(19) United States
(12) Patent Application Publication
(10) Pub. No.: US 2025/0222644 A1
(43) Pub. Date: Jul. 10, 2025

(54) Method for producing containers, and facility for implementing the method

(71) Applicant: SIDEL PARTICIPATIONS, OCTEVILLE-SUR-MER (FR)

(72) Inventors: Arnaud DELAUNAY, OCTEVILLE-SUR-MER (FR); Julien GENDRE, OCTEVILLE-SUR-MER (FR); Pierrick PROTAIS, OCTEVILLE-SUR-MER (FR)

(21) Appl. No.: 18/724,257

(22) PCT Filed: Dec. 27, 2022
(86) PCT No.: PCT/EP2022/087883

§ 371 Date: Jun. 26, 2024

(30) Foreign Application Priority Data
Dec. 30, 2021 (FR) 2114701

(51) Int. Cl. B29C 49/78; B29C 49/42

(52) U.S. Cl. CPC B29C 49/786; B29C 49/42413; B29C 2049/7861; B29C 2049/78675; B29C 2049/78715

(57) ABSTRACT

A method for producing containers from preforms. In example embodiments, the containers can have different formats. In example embodiments, the method includes thermal conditioning of a preform made of a thermoplastic material, moulding by blow-moulding or stretch blow-moulding of the container by means of a unit for forming containers, and calibration. The calibration includes providing a sample preform for said format; placing, on said sample, at least two reference markers distributed along the height of said sample; thermally conditioning the sample and blow-moulding the sample in order to obtain a container according to said format; reading off the position of the reference markers on said container obtained; and assigning each of the heating means to at least one of the three portions on the basis of the position of the reference markers on said container obtained. The invention also relates to a facility implementing the production method.

### CROSS-REFERENCE TO RELATED APPLICATION

This application claims priority to Patent Cooperation Treaty Patent Application No. PCT/EP2022/087883 filed Dec. 27, 2022, which claims priority to French Patent Application Serial No. 2114701 filed Dec. 30, 2021, the entirety of which is incorporated herein by reference.

### TECHNICAL FIELD

The present invention relates to the field of the manufacture of containers by blow molding or stretch blow molding from preforms made of thermoplastic material, such as polyethylene terephthalate, hereinafter “PET”, for example. The subject of the present invention is a method for producing containers from preforms and a facility implementing such a method.

### Prior Art

Within the meaning of the present invention, the container is a bottle or a jar. Manufacture of such containers requires a facility that comprises a heating unit and a forming unit, equipped with a succession of molds the molding cavity of which match the model of container that is to be formed, and with corresponding injection devices.

The manufacturing facility generally comprises a control unit from which numerous parameters relating to the heating unit can be manually adjusted, for example: heating temperature, speed of travel of the preforms, power of ventilation used to remove some of the heat, etc.

In the known way, the production of thermoplastic containers involves two main phases. The first phase is a phase of thermal conditioning of the preforms, during which phase a succession of preforms is heated to a reference temperature. This step enables the preforms to be in a malleable state in which they can subsequently be formed. The second phase is a forming phase, during which each previously heated preform is transferred into a molding-cavity mold belonging to the forming unit so as to allow a pressurized fluid to be injected into each preform by the corresponding injection device, also referred to as blow pipe, to confer upon the preform the final form of the container. The pressurized fluid is, for example, a gas, such as air. The forming phase generally includes a stretching phase performed by means of a mobile rod designed to apply a stretching force to the bottom of a preform in a mold in order to stretch the preform along its axis, this contributing to keeping the preform centered relative to the mold.

The production method requires numerous preliminary attempts by trial and error before a container deemed to be compliant, which is to say a container that meets all of the quality criteria defined beforehand by a technical specification, is obtained. The operation is painstaking and long to implement because it is absolutely essential for each of the parameters of the facility and of the method to be adjusted in order to ensure the compliance of the container. Furthermore, this preliminary step has to be carried out for each format of container. The format of the container may notably be defined by the height, the shape, the volume, the material thereof.

The optimization of the production method and the setting of the parameters of the associated facility therefore requires the presence of an operator who has intimate knowledge of the facility, of the method and of the models of preform likely to be introduced into said facility in order to obtain a container compliant with the desired format. This optimization also takes a significant amount of time, which has a direct impact on the production volume of the line.

The container obtained will then be evaluated in order to determine whether or not it meets the criteria, and this will be repeated throughout the production phase.

For example, one quality criterion against which the compliance of a container is assessed may be the distribution of the material along the height of the container, for a determined format. As is known, one of the parameters of the production method that has an impact on this criterion is the thermal conditioning of the preforms.

If this material-distribution criterion is assessed as not being compliant, the operator has to adjust various parameters in order to correct the defect, either during the thermal-conditioning phase, or during the forming phase, or both. Furthermore, the modifications made must not cause other defects or problems to arise.

There is therefore still a need to optimize the production method by simplifying the control of the various steps and the setting of the parameters of the facility. In particular, there is still a need for better control over the phase of thermal conditioning of the preforms in order to achieve a more targeted correcting of the parameters involved in this step, so as to shorten the time needed to obtain a first compliant container for a new format.

It is absolutely essential to be able quickly and precisely to correct a defect detected during the production of containers and therefore to adjust the various parameters efficiently, so as not to have an impact on the production workflow.

### Technical Background

Document US20110260350 proposes modifying the overall power of the heating cavity without specific intervention on the zone in which a defect has been detected. Thus, the thermal conditioning is not adjusted sufficiently precisely. Specifically, as will be described later on, a container may be partially compliant, at a given level along its height, for example in its body, and non-compliant at another level. It may also be entirely non-compliant. The correction method proposed by this document is unable to optimize the production process satisfactorily. Moreover, it does not make it possible to avoid new defects arising, induced by the corrections themselves.

The current solutions are insufficient because they do not allow the operator to optimize the preform-heating phase directly and quickly. The information that the operator has at their disposal does not allow the defect to be corrected while at the same time avoiding causing other problems to arise, for example at other levels along the height of the container.

### SUMMARY OF THE INVENTION

In the field of the invention it is therefore necessary to develop a method for the production, by molding or stretch-blow-molding, of containers that is quick to implement, does not require a an excessively lengthy optimization phase, and can be easily adapted in the event of a change in format or of a new defect arising.

The invention thus seeks to provide a method for producing containers that is both reliable and easy to implement.

The invention also targets the facility for implementing this method.

Thus, in the event of a change in format or of a defect arising, the method will be adapted accordingly and the production workflow of compliant containers will be able to be resumed quickly.

### Brief Description of the Invention

In order to achieve this, the invention proposes a solution that seeks to allocate the heating means that heat a sample preform to defined sections of a container so as to allow more precise control of the thermal conditioning during the course of the production of a container by molding. The fact that it is known precisely which heating means are attributed to a given section of the container means that the heating power of each heating means can be corrected on the basis of the defects detected in one or more sections. In the context of the invention, it will be possible to establish the precise impact that the heating means used in the thermal conditioning of a sample preform have on defined sections of the container obtained. In other words, it will be known precisely which heating means it is that directly influence the compliance of a section of a container.

To this end, the invention relates to a method for producing containers from preforms, said containers being able to have different formats, each format of container having at least three sections along the height of the container, the method comprising at least the following steps of:
thermally conditioning a preform made of a thermoplastic material, said thermal conditioning being performed by at least one heating unit comprising at least one heating module, said heating module comprising several heating means positioned one above the other;
blow-molding or stretch-blow-molding the container by means of a forming unit for the forming of containers.

The method is characterized in that it comprises a calibration step for at least one of the formats of container, comprising the following actions in succession:
supplying a sample preform for said format;
applying to said sample at least two reference markings distributed along the height of said sample, each of the at least two reference markings being associated with at least one heating means;
thermal conditioning of said sample and blowing of said sample in order to obtain a container to said format,
capturing of the position of the reference markings on said container obtained;
attributing of each of the heating means to at least one of the three sections according to the position of the reference markings on said container obtained.

Prior to beginning a production cycle for one format of containers it is advantageous, during a calibration step, to test the production parameters of the method by using one or more samples of a preform. The sample preform corresponds to the preform for the container that is to be obtained. In other words, the sample is representative of the preforms that will be used for the container production cycle and has the same characteristics. In brief, a sample is a specimen of a preform for a given format of container.

According to the invention, the use of a sample during the calibration step makes it possible to determine the impact, during the thermal conditioning of the preform for a given format of container, that one or more heating means will have on different sections of the container. In other words, it is then possible, advantageously, to know which are the heating means directly associated with the manufacture of one or more given sections of a container: which are the heating means that act directly for example on the bottom of the container, on the body thereof, etc. That then makes it possible to quickly and easily to identify one of the possible causes of a defect with a container.

The invention also relates to a container production method which comprises a step of controlling the wall thickness of the wall of the containers at the sections, said control being performed by means of a control unit, said unit comprising detection means comprising at least two sensors, and the control step involving comparing said thickness measurement against a setpoint value.

According to one additional feature, for at least one section, the thickness is measured by its corresponding sensor at the lower limit and/or at the upper limit of said section.

According to other embodiments, the production method comprises an automatic step of regulating the power of at least one heating means on the basis of the measured thickness for the section to which said means is attributed.

According to other embodiments, the step of applying reference markings to the sample consists in laser marking the circumference of said sample at a minimum of two heights.

According to yet other embodiments, during the thermal conditioning, each reference marking applied to the preform faces a heating means, and in particular faces the heating means with which it is associated.

Another subject of the invention is a facility for producing containers for implementing the method.

The invention relates to a facility for producing thermoplastic containers according to the production method of the invention, said containers being able to have different formats, each format of container having at least three sections along the height of the container, said facility comprising:
a heating unit comprising at least one heating module, said heating module comprising several heating means positioned one above the other,
a forming unit for the forming of containers, this unit comprising at least one forming station, said forming station each including a mold the molding cavity of which matches a container, and at least one injection device for injecting a pressurized fluid into the preform.

The facility is characterized in that it comprises calibration means comprising means for applying, to a sample preform, at least two reference markings that are distant from one another along the height of said sample, and attribution means for attributing each of the heating means to at least one of the three sections on the basis of the position of the reference markings on said container obtained at the exit of the forming unit.

According to an additional feature, the facility comprises a control unit for controlling the wall thickness of the wall of the containers at a minimum of two height levels, said control unit comprising detection means, said detection means comprising at least two sensors situated one above the other each at a respective height level of said container, and said control unit comprising an automatic control system.

According to certain embodiments, the control unit forms the attribution means and the detection means.

According to other embodiments the calibration means comprise means for laser marking at least two reference markings on the circumference of the sample.

In certain embodiments, within the conditioning unit, each reference marking on the preform faces a heating means, and in particular faces the heating means with which it is associated.

According to another feature, the calibration means comprise means for laser marking at least two reference markings on the circumference of the preform at a minimum of two heights.

According to certain embodiments, the calibration means comprise means for ink-jet printing at least two reference markings on the circumference of the preform at a minimum of two heights.

According to other embodiments, the calibration means comprise means for engraving at least two reference markings on the circumference of the preform at a minimum of two heights.

### BRIEF DESCRIPTION OF THE FIGURES

The invention will be understood better from the description below which is based on possible embodiments, explained illustratively and in a non-limiting manner, with reference to the attached figures, in which:

FIG. 1 depicts an overall view, from above, of a production facility;

FIG. 2 depicts a schematic side view of a heating module and of a blowing station;

FIG. 3 depicts a schematic face-on view of a container and of the thickness sensors at different height levels, defining sections;

FIG. 4 depicts a schematic face-on view of the reference markings marked onto a preform by hand and corresponding to the reference markings marked on a container;

FIG. 5 depicts an illustrative example of how the sections are determined by laser marking;

FIG. 6 depicts an example of the application of reference markings to the preform during the calibration step, in which each reference marking is marked at the same level, along the height, as a corresponding heating means;

FIG. 7 depicts the obtaining of different formats of container from preforms, notably showing the reference markings specific to each format;

FIG. 8 depicts the step of attributing the reference markings to different sections.

### DETAILED DESCRIPTION OF THE INVENTION

In the remainder of the description, elements exhibiting an identical structure or equivalent functions will be denoted by the same reference.

Facilities for the mass production of thermoplastic containers 1 from preforms 2 have been depicted schematically in the figures.

In the remainder of the description, the preforms 2 and the containers 1 travel through the production facility along a circulation path from upstream to downstream. The preforms 2 are moved in line along a heating path by conveying means that will be detailed hereinafter.

Nonlimitingly, the containers 1 in this instance are bottles. The thermoplastic material is, for example, formed here by polyethylene terephthalate referred to hereinafter by its acronym “PET”.

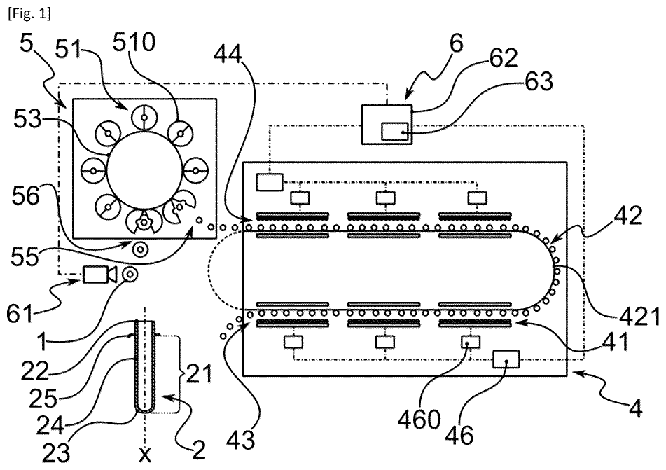

FIG. 1 depicts an example of such a preform 2. The preform 2 has a main axis “X” depicted vertically in FIG. 1. It has a cylindrical body 21 with a tubular wall which is closed at one of its axial ends by a bottom 23 and which is open at its other end via a neck 22 which is likewise tubular. At its base, the neck 22 here has a neck ring 25 which is used for transporting it through the production facility.

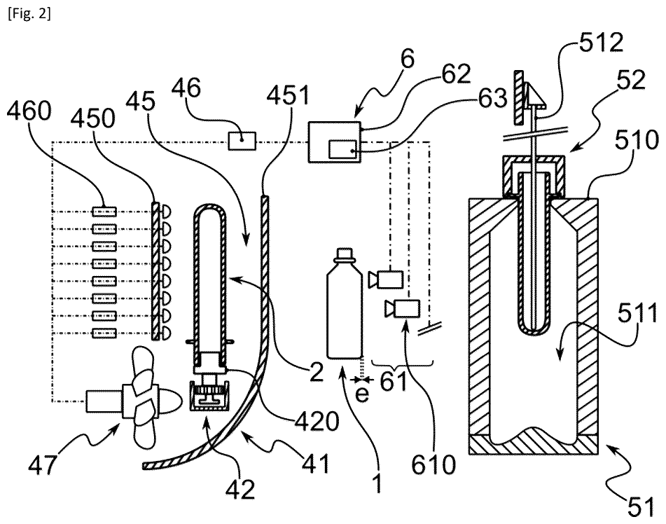

As depicted in detail in FIG. 2, the wall 24 is delimited by an external face and by an internal face. The neck 22 generally already has its definitive shape, whereas the body of the preform is intended to be subjected to a relatively significant deformation to form the final container 1 during a forming step.

As depicted in FIG. 1, the production facility comprises a heating unit 4, a forming unit 5 and a control unit 6 of the production facility, which notably comprises a computer (or processor), a memory and a console (or graphic interface), not depicted, to interface with an operator.

The heating unit 4, also referred to as thermal conditioning unit or even oven, enables a succession of preforms 2 to be heated to a reference temperature. The reference temperature is chosen so that the body 21 of each preform 2 at the exit 44 of a heating unit 4 is in a malleable state allowing the body 21 of the preform 2 to be deformed in order to form the container 1 in the forming unit 5. The reference temperature for the forming of the preform is comprised between the glass transition temperature and the crystallisation temperature of the thermoplastic material of the preform 2. In the case of PET, the reference temperature is, for example, around 110°. The value of the reference temperature may vary according to the product with which the container 1 is to be filled, or according to the technique used for filling said container. Thus, the reference temperature for hot-filling or for a carbonated product for example differ. It will be noted that the reference temperature corresponds to the temperature at a reference point on the preform 2, namely in a localized zone. This is because the preform 2 is not necessarily heated to a uniform temperature but may exhibit a temperature profile along its height that is dependent on the desired material distribution for the container 1, along the height thereof.

It will therefore be appreciated that it is advantageous to identify precisely, for a format 3 of container 1, which are the heating means 410 that truly and precisely act upon at least one section 8 of this container 1. The calibration step implemented by the invention makes it possible to meet this need.

In some embodiments, the heating unit 4 comprises at least one heating module 41.

According to one embodiment, depicted in FIG. 1, the heating unit 4 is a pass-through oven through which the preforms 2 are transported in order to be exposed to several successive heating modules 41 distributed along the heating path. Said at least one heating module 41 comprises a plurality of heating means 410 formed on side walls 450.

As depicted in FIG. 1, the heating module 41 also comprises at least one heating cavity 45 which comprises two side walls 450 facing and distant from one another, and at least one of these walls is the one that supports several heating means 410 arranged one above the other along a height of the preform 2 so that the entire height of the body 21 of each preform 2 is exposed to the heating means 410 as the preform 2 follows its path through said heating unit 4.

Thus, it should be noted that a preform 2 is not necessarily exposed to a uniform temperature during the cycle via which it is transformed into a container 1, whether along the path it travels through the facility or along its height. This is why a calibration step according to the invention is particularly advantageous.

According to one embodiment, as depicted in FIG. 1, the heating means 410 in the heating modules 41 are distributed on just one side of this path, in which case a reflective wall 451 is positioned on the other side of the heating path in order to reflect the heat back toward the preforms 2.

In another embodiment, not depicted, the heating means 410 may be distributed on both sides of the heating path in the heating module 41.

According to one embodiment, the heating means 410 are arranged one above the other and one next to the other facing the preforms 2, thus defining a matrix array of heating means 410 with respect to the heating path followed by the preforms 2.

According to another embodiment, the heating means 410 form one same single column in the heating module 41.

According to certain embodiments, the heating means 410 are arranged in the heating module 41 in such a way as to subject the body 21 of the preform 2 to radiation thus defining a suitable temperature profile through the wall of the preform 2 from the outside toward the inside. Those zones of the preform 2 that have a lower temperature lead to thicker walls in the molded container 1, whereas the hotter zones of the preform 2 are stretched more during the blowing operation and thus lead to a thinner wall in the container 1.

This arrangement of the heating means 410 will therefore have an impact that varies according to the format 3 of container 1 that is to be obtained. The use of a sample preform 2 in order to calibrate the method is therefore particularly advantageous for gaining better control over the production cycle and obtaining containers 1 that are fully compliant, which means to say of satisfactory quality.

In one embodiment, the heating means 410 are arranged in the heating module 41 in such a way as not to subject the neck 22 and the neck ring 25 to the heat emitted by said heating means. Specifically, as indicated previously, only the body 21 of the preform 2 is shaped in order to produce the container 1. As a result, the neck 22 and the neck ring 25 must not be deformed during the forming step and therefore must not be heated. According to an additional feature, in order to prevent the heating of the neck 22 and of the neck ring 25, the heating unit 4 comprises a ventilation device positioned at the necks 22 and the neck rings 25 in order to remove the heat that said necks and said neck rings 25 might be liable to absorb. The ventilation device for example comprises at least one fan 42 controlled by the control unit 6.

In some embodiments, the arrangement of the heating means 410 is the same for all the heating modules 41.

According to one embodiment, each heating means 410 is formed by an incandescent bulb emitting infrared radiation.

In another embodiment, each heating means 410 is a laser diode emitting infrared radiation.

According to yet another embodiment, each heating means 410 is a halogen bulb.

It is entirely possible to combine several different heating means 410.

In other words, each heating means 410 is heating of the radiant type, emitting heat by radiation, of the laser type (for example laser diodes). Each heating means 410 emits in the infrared. The heating means 410 are organized as a superposition and/or a juxtaposition in order to form one or more matrix arrays within a heating module 41.

In one embodiment, each matrix array is a vertical cavity surface emitting laser diode (VCSEL) matrix array, each diode emitting, for example, a laser beam of an individual power of the order of one Watt at a wavelength of around 1 μm.

In order to allow the preforms 2 to move along a heating path, the heating unit 4 comprises a conveying means 42 conveying said preforms 2 through the heating unit 4 along a heating path that extends between an entrance 43 and an exit 44 of said unit.

As depicted in FIGS. 1 and 2, the conveying means 42 comprises a succession of supports 420, each able to support a preform 2, which are mounted on a chain 421 moving along the heating path through the heating unit 4.

In one embodiment, not depicted, the conveying means 42 comprises, for example, a succession of supports 420, each able to support a preform 2, which are mounted on a shuttle of the linear motor type circulating in a closed magnetic loop. The movement of each of these shuttles is controlled independently of one another by the control unit 6.

According to one embodiment, as depicted in FIG. 2, each support 420 is able to receive a preform 2 by pushing the neck 22 onto said support. Each support 420 is for example able to rotate with respect to the chain 421 about an axis of rotation coincident with the main axis X of a preform 2 when this preform is being supported by said support.

According to one embodiment, the heating means 410 are distributed as a matrix array in a heating module 41, along the heating path and in a direction transverse with respect to said path, the transverse direction being substantially parallel to the main axis X of the preforms 2 when they are being supported by the supports 420.

By causing the preforms 2 to rotate about their main axis X, the supports 420 allow the entire body 21 of the preforms 2 to be exposed uniformly to the heating means 410.

The heating unit 4 also comprises an electrical power supply 46 supplying each heating means 410 with electrical power. Each heating means 410 converts the electrical power supplied to it into radiation that heats the preforms 2.

The electrical power supply 46 allows each of the heating means 410 to be powered individually so that it is possible to control them independently. That makes it possible to determine which heating means 410 are used and to what level of intensity along the path for heating the preforms 2 passing through the heating unit 4 by means of at least one heating module 41. The distribution of the heating means 410 which are or are not powered, and the level of power, along the path and in the transverse direction, is generally referred to as the “mapping” of the heating means 410.

The electrical power supplied to the heating means 410 may therefore also be variable between a maximum electrical power and a minimum effective electrical power of the heating means 410. What is meant by “maximum electrical power” is the maximum electrical power to which the heating means can be subjected without damage and what is meant by “minimum effective electrical power” is the minimum electrical power upward of which the heating means emits radiation capable of heating a preform 2.

The electrical power is expressed directly as power, which is to say in Watts, or as a percentage of the maximum electrical power of a heating means 410.

The container forming units 5 is formed by a forming carousel 53 rotating through a plurality of forming stations 51 from an entrance 55 to an exit 56, at which a succession of containers 1 formed from preforms 2 is extracted, as depicted in FIG. 1. The axis of rotation of the forming carousel 53 is for example substantially parallel to the main axis X of the preforms 2 when they are being transported by the forming carousel.

Each forming station 51 comprises a mold 510 forming a molding cavity 511 that has the shape of the container 1 that is to be formed and is designed to accept a preform 2 in such a way that the body 21 of the preform 2 extends into the molding cavity 511, as depicted in FIG. 2. Each mold 510 is formed of several parts able to move between an open position, in which the mold is able to accept a preform 2 and release a container 1 at the entrance 55 and the exit 56 respectively, and a closed position, in which the molding cavity 511 is closed onto the preform 2 between the entrance 55 and the exit 56. When the preform 2 is received in the mold 510, the body 21 extends into the molding cavity 511 and the neck 22 of the preform projects out of the mold 510 outside the molding cavity 511, as depicted in FIG. 2.

Each forming unit 5 further comprises at least one injection device 52 designed to inject a fluid into the internal volume of the preform 2 placed in the mold 510 of the forming station 51 so that the fluid deforms the preform 2 and the latter takes on the shape of the molding cavity 511, namely so that the preform 2 is formed into a container 1 under the action of the fluid. According to one embodiment, the fluid is, for example, a pressurized gas, for example pressurized air. In this case, the injection device 52 is formed by a blow pipe and comprises one or more valves enabling control of the injection of the fluid into the preform 2. The pressure at which the fluid is injected can be regulated. By way of example and in a known manner, not illustrated here, the forming unit 5 comprises one reservoir of pressurized air at a first pressure and another reservoir of pressurized air at a second pressure, the valves enabling selective injection of air at the first pressure or at the second pressure.

According to one embodiment, depicted in FIG. 2, each forming station 51 also comprises a stretch rod 512 able to move relative to the mold 510 in a direction coincident with the main axis X of the preform 2 when the preform is placed in said mold. The stretch rod 512 is designed to apply pressure to the bottom 23 of the preform 2 in order to stretch this preform in the axial direction. More particularly, the stretch rod 512 stretches the preform 2 until the bottom 23 of the preform 2 comes into contact with the bottom of the molding cavity 511. The movement of the stretch rod is controlled by an actuator which is either a mechanical actuator of the actuating cylinder type controlled by a cam and cam-follower system, or an electric actuator of the linear motor type.

The forming unit 5 is controlled automatically by a control unit 6.

As depicted in FIGS. 1 and 2, the production facility comprises a control unit 6 connected to the electrical power supply 46.

The control unit 6 controls the electrical power supply 46 of the heating unit 4 via power regulators 460.

The power regulators 460 make it possible to vary the electrical power of the heating means 410, at input to the heating module 41, between the maximum electrical power and the minimum effective electrical power. These regulators may be of analogue type or of electronic type.

The control unit 6 advantageously regulates the electrical power supply or supplies and/or the regulator or regulators 460 of each heating means 410.

As depicted in FIG. 1 and in FIG. 2, the control unit 6 comprises a memory 63 in which there are recorded at least one electrical-power setpoint for at least one row of heating means and/or at least one column of heating means 410 and at least one thickness setpoint for at least one level along the height 9 of the container 1.

According to one embodiment, the setpoints are recorded in the memory 63 of the control unit 6 by an operator.

The setpoints are, for example, determined empirically on the basis of trial and error or from databases of earlier preforms 2 heated with a view to obtaining a container 1.

The control unit 6 takes at least one measurement of the thickness of a wall of the container at least at one height level 9 using the detection means 61.

According to the invention, the detection means 61 comprise at least two sensors 610.

As illustrated in FIG. 1, the thickness-measuring detection means 61 are placed at the exit 56 of the forming unit 5 in order to measure, at a point, at a predetermined level along the height 9, the thickness of the container 1 that has just been formed.

In one embodiment, the detection means 61 comprise at least two sensors 610 of optical type.

Alternatively, in an embodiment which has not been depicted, the thickness-measuring detection means 61 are placed inside the mold. In this case, the detection means 61 may be sensors of capacitive type.

In order to be able to assess the compliance of the container 1 formed over the entirety of its height, it is advantageous to position several sensors 610, one above the other, along the height 9 of the container 1. The height 9 of a container extends in the direction parallel to the axis of symmetry of said container 1.

In some embodiments, the detection means 61 of the control unit 6 comprise at least two sensors 610 for measuring the thickness along the height of the container 1.

In some embodiments, for each container 1, the control unit 6 compares the thickness measurement obtained via at least two sensors 610 against the corresponding thickness setpoint recorded for this height level:
if the thickness measurement and the thickness setpoint are identical, then the control unit 6 does not modify the electrical power supplied to the heating means 410.
if the thickness measurement differs from the thickness setpoint, then the control unit 6 modifies the electrical power supplied to at least one heating means 410.

According to an optional feature, if the control unit 6 notices a thickness defect at least at one height level 9, it then modifies the electrical powers of at least two heating means 410. As a preference, the sum of the electrical powers supplied to all of the heating means 410 remains identical throughout the method for producing the containers 1 for each heating module 41 and preferably for the heating unit 4. In other words, according to one embodiment, an increase or a lowering of the electrical power of one heating means 410 will lead to a lowering or to an increase of at least one other heating means 410 so that the sum of the electrical powers remains the same for at least one heating module 41: the overall electrical power associated with the heating means 410 remains constant overall.

In order to be able to optimize the setting of the electrical power parameters for the heating means 410, the invention therefore proposes establishing the relationship between the position of a heating means 410 and the targeted impact it has on at least one section 8 of a container 1 obtained.

It must be appreciated that, in certain embodiments, the height of a sensor 612 may differ significantly from the height at which the wall thickness is measured by this sensor. This is because, in certain embodiments, the shape of the preform 2 and/or of the container 1 necessitates positioning the sensor at a significantly different height so that said measurement will be optimal.

According to one embodiment, the lower limit 810 or the upper limit 820 of a section 8 corresponds to the height 9′ at which the thickness is measured by a sensor 610.

In one preferred embodiment, the height 9 at which the thickness is measured by a sensor 610 corresponds to the height 9 at which said sensor 610 is positioned.

According to some embodiments, the detection means 61 of the control unit 6 comprise at least two sensors 610 and the container 1 comprises at least three sections 8, each section having a lower limit 810 and an upper limit 820, each lower limit 810 and/or each upper limit 820 of at least one section 8 corresponding to a height 9 of a sensor 610.

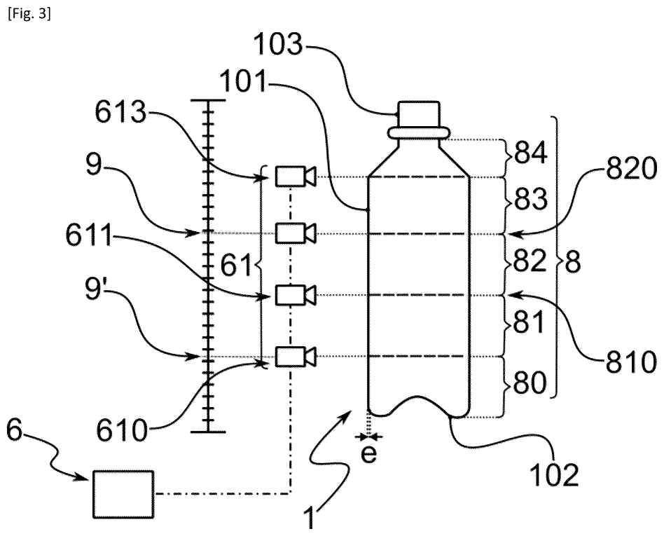

As in the embodiment illustrated in FIG. 3, the container 1 comprises for example five sections 80, 81, 82, 83 and 84. The section 80 situated at the lowest height level starting from the bottom 102 of the container 1 has as its lower limit the bottom 102 of said container 1 and as its upper limit the height corresponding to the first thickness sensor 610. The section 84 situated at the highest height level starting from the bottom 102 of the container 1 has as its lower limit 810 the height corresponding to the last thickness sensor 613 and as its upper limit 820 the neck 103 of said container 1. The other, intermediate, sections 81, 82 and 83 have lower limits 810 and upper limits 820 that correspond to different sensor height levels, as depicted in FIG. 3. In particular, in the embodiment illustrated, the lower limit 810 of the section 82 corresponds to the upper limit 820 of the section 81.

In the embodiment depicted in FIG. 3, the control unit 6 comprises four sensors 610 and the container 1 comprises five sections 8 along its height. Each sensor 610 is situated at a different level along the height 9.

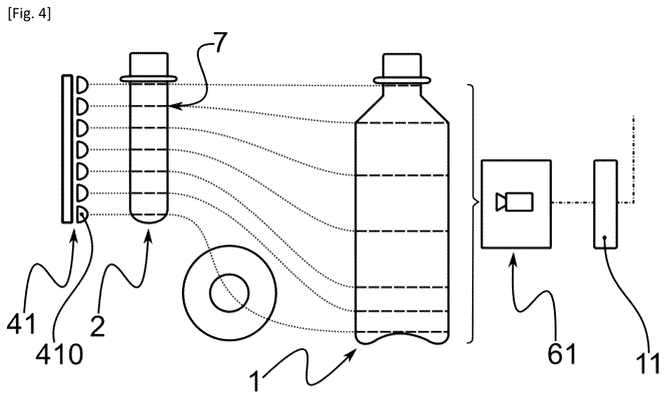

In one embodiment, as illustrated in FIG. 4, the production facility further comprises calibration means 10, said calibration means applying at least two reference markings 7 along the height of the sample preform 2. Each of the two reference markings 7 is associated with at least one heating means 410.

According to some embodiments, the calibration means 10 are situated upstream of the heating unit 4 in the production facility.

In some embodiments, the at least two reference markings 7 are applied to just part of the wall of the sample preform 2, at minimum at two heights on said sample. According to another variant, the at least two reference markings 7 are applied to the wall of the sample preform, over the entire circumference of said sample.

The at least two reference markings 7 are applied at minimum at two predetermined heights. The height level is predetermined by the position of the heating means 410 in the heating module 41.

The at least two reference markings are applied at minimum at two different heights, the respective positions of which are determined by the position of the singular or plural heating means with which they are associated. The position, which is to say the height, of a reference marking 7 is therefore determined by the height of at least one heating means 410.

In some embodiments, the calibration means 10 are means for ink-jet printing at least two reference markings 7 on the circumference of the sample preform 2, each of the at least two reference markings 7 being associated with at least one heating means 410.

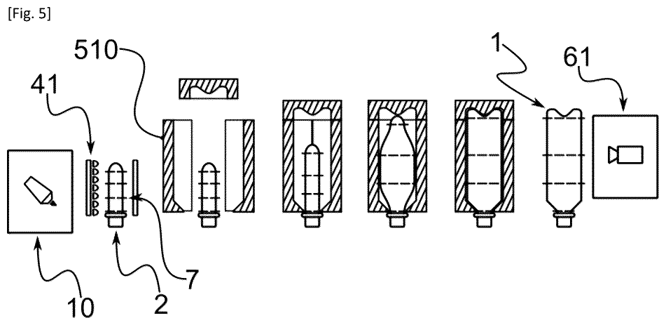

According to another variant illustrated in FIG. 5, the calibration means 10 are laser marking means. In this example, four reference markings are applied to the wall 24 of the sample preform 2.

In another embodiment, the calibration means 10 are engraving means.

According to the invention, any means that enables a reference marking 7 to be applied to the wall of the sample preform 2 may be a calibration means 10. In particular, according to yet another variant, an operator may apply the at least two reference markings 7 by hand.

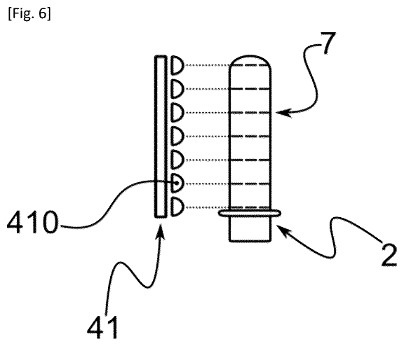

As a preference, according to an embodiment illustrated in FIG. 6, each reference marking 7 is applied to the wall of the sample preform 2 at the height at which a heating means 410 is situated. In other words, the reference marking 7 and the heating means 410 face one another. In one embodiment, the height of the heating means 410 corresponds to the point at which the heat source is at its maximum, which is to say to the point at which the heat is most concentrated, at which the heat source is situated.

Each of the reference markings 7 is therefore associated with a heating means 410 and is applied to the wall of the sample preform 2 at the height at which the heating means 410 is situated in the heating module 41. In a variant, a first reference marking 7 is marked, corresponding for example to the first heating means 410, which is to say corresponding to the heating means 410 situated at the lowest height. The lowest-down, which is to say the first, heating means 410 is associated with the first reference marking 7. The second heating means 410 is then associated with a second reference marking 7, and so on. Each reference marking 7 may also be marked on the basis of the distance separating each heating means 410 in the heating module 41 in the heightwise direction. Each heating means 410 therefore has a reference marking 7 facing it.

In other embodiments which have not been depicted here, each reference marking 7 is applied at a level along the height that corresponds to a point situated between two heating means 410. In other words, the at least two reference markings 7 are marked on the wall of the sample preform 2 according to a predefined rule that establishes the ratio connecting the level, along the height, of a heating means 410 in the heating module 41 on at least one side wall 45 and the level, along the height, of the reference marking 7 marked on the wall of the preform 2. According to a preferred embodiment, this ratio is equal to one.

In the context of the invention, the reference marking 7 may consist of a line, a dot, or any other means enabling the preform 2 to be marked in a visual and readily identifiable manner. The line may extend all the way around the preform 2, continuously or otherwise, for example as a dotted line. The line may also be partial. The reference marking 7 may just as easily be a dot, a cross, etc.

In a preferred embodiment, as depicted in FIG. 6, each reference marking 7 corresponds to a single heating means 410. A reference marking 7 is therefore associated with a single heating means 410 and, reciprocally, each heating means 410 is associated with a single reference marking 7. In other words, there are as many reference markings 7 as there are heating means 410. After the reference markings 7 have been applied to the sample preform 2, and after the steps of thermally conditioning and blow-molding said sample, the position of each of the reference markings 7 is captured on the container 1 obtained. The heating means 410 associated with a reference marking 7 is attributed to at least one section 8 according to the position of said reference marking, which is to say according to its level along the height 9. What is meant by “attributing” a heating means 410 to at least one section 8 is that a heating means is assigned to at least one section 8. This is particularly advantageous because the radius of action of each heating means 410 on the preform 2 and then on the container 1 can then be easily identified and thus it is possible to determine which of the heating means 410 are involved in the thermal conditioning of the preform, particularly at the level, along the height, at which a defect is identified.

Thus, the step of applying the reference markings 7 allows at least one heating means 410 to be associated with at least one reference marking 7 according to a predetermined rule. It is the position of the heating means 410 within the heating module 41, namely its height, or else its relative position with respect to the other heating means 410 of said module 41 that will determine with which reference marking 7 it will be associated. The reference marking 7 is not necessarily applied facing the heating means 410 with which it is associated, but the order in which the reference markings 7 feature on the sample preform must correspond to the order in which the heating means 410 feature in the heating module 41.

Next, the position of each reference marking 7 will be captured and, depending on its height on the container 1 obtained, it is then easy to determine which of the heating means 410 have impacted the thermal conditioning of a section 8 of the container 1. In particular, the first heating means 410 in the heating module 41, which means is associated with the first reference marking, will be attributed to the first section of the container 1, counting from the bottom 102 thereof. During the capture of each reference marking 7 it will be determined in which section 8 this marking lies. Next, because it is associated with at least one heating means 410, said at least one heating means 410 will be attributed to the corresponding section 8.

According to other embodiments, the production facility also comprises attribution means 11. According to the position of the reference markings 7 on the container 1 obtained, for at least one given format 3, the attribution means 11 will allocate the heating means 410 to at least one of the previously determined sections 8. In other words, each heating means 410 is first of all associated with a reference marking 7 so that it can then be attributed to a section 8. Thus, each heating means 410 will be attributed to at least one section 8.

According to some embodiments, a heating means 410 is attributed to two sections 8. This may notably be the case when said heating means 410 is situated at the same height as the lower limit 810 or at the same height as the upper limit 820 of a section 8.

According to other embodiments, in instances in which the heating means 410 is situated at the same height as the lower limit 810 or at the same height as the upper limit 820 of a section 8, it is attributed to the section situated below this limit.

According to another preferred embodiment, in instances in which the reference marking 7 associated with a heating means 410 is situated at the same height as the lower limit 810 or at the same height as the upper limit 820 of a section 8, the associated heating means 7 is attributed to the section situated above this limit. The attribution step is performed by locating the reference markings 7, for example visually. The heating means 410 is attributed to at least one section 8 according to the position of a reference marking 7.

According to a preferred embodiment, a heating means 410 is attributed to one of the sections 8 according to the position of the reference marking 7 with which it is associated. In other words, a heating means 410 is then associated with a single section 8.

In certain embodiments, at least one heating means 410 is not attributed to any of the sections 8.

In one preferred embodiment, at least one heating means 410 is attributed to one section 8.

In some embodiments, each of the sections 8 may have zero, one or several heating means 410 attributed to them. According to another possible feature, at most five heating means 410 are attributed to each section 8, preferably at most three heating means 410.

In some embodiments, when the heating means 410 are laser diodes, each section 8 comprises at most twenty heating means 410, preferably at most seven heating means 410.

The attribution means 11 comprise measurement means able to measure the height of the reference markings 7 on the formed container in order to capture the respective position thereof.

These means are, for example, viewing means.

The attribution means 11 also comprise calculation means for processing the information originating from the measurement means. The viewing means will capture the position of the reference markings 7 on the container 1 obtained and then the calculation means will process the information and attribute each heating means 410 associated with a reference marking 7 to at least one section 8.

According to one additional feature, the information originating from the measurement means may be processed by the control unit 6.

In another embodiment, the at least two sensors 610 may also form the attribution means 11. This is notably possible when the at least two sensors 610 comprise a viewing camera. In this embodiment, the measurement means of the attribution means 11 are formed by the at least two sensors 610. In this embodiment, the control unit 6 comprises the attribution means 11 and the detection means 61.

According to a preferred embodiment, the container 1 comprises four sensors 610, five sections 8, and the same number of reference markings 7 as there are heating means 410.

The invention also relates to a method for producing containers 1 from preforms 2, said method employing the production facility described above.

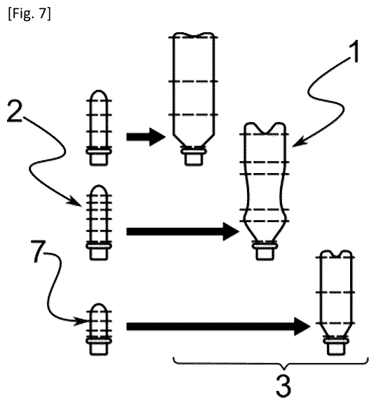

According to the invention, the method is implemented for at least one format 3 of containers 1. Specifically, as illustrated in FIG. 7, the reference markings 7 marked on a sample preform 2 will be situated at different heights along the container 1, depending on the container format 3. Likewise, for the one same sample preform 2, the distribution of the reference markings 7 along the container 1 may vary according to the desired final format 3, notably with reference to the thermal conditioning of said preform 2.

The format of a container 1 varies notably according to the exterior contour of said container, the volume thereof and the height thereof. For formats 3 that are similar, having similar characteristics, it is not always necessary to perform a new calibration step starting with a sample. In other words, according to one embodiment, it is possible to perform the calibration step just once for different formats 3 of containers, when said formats 3 have characteristics in common. For example, such may be the case for formats 3 of containers that have the same height, the same volume, but a slightly different exterior contour.

According to one preferred embodiment, the calibration step is performed each time the format 3 of container 1 is changed.

In some embodiments, the method for producing containers 1 from preforms 2 is implemented for containers 1 that may have different formats 3, each format 3 of container 1 having at least three sections (8) along the height (9) of the container (1) and comprising at least the following steps of:
thermally conditioning a preform 2 made of a thermoplastic material, said thermal conditioning being performed by at least one heating unit 4 comprising at least one heating module 41, said heating module 41 comprising several heating means 410 positioned one above the other;
blow-molding or stretch-blow-molding the container 1 by means of a forming unit 5 for the forming of containers 1.

The method is characterized in that it comprises a calibration step for at least one of the formats (3) of container (1), comprising the following actions in succession:
supplying a sample preform 2 for a format 3;
applying to said sample at least two reference markings 7 distributed along the height of said sample, each of the at least two reference markings 7 being associated with at least one heating means 410;
capturing of the position of the reference markings 7 on said container 1 obtained;
attribution of each of the heating means 410 to at least one of the three sections 8 according to the position of the reference markings 7 on said container 1 obtained.

The at least two reference markings 7 are applied along the height of the sample preform 2 using calibration means 10. The at least two reference markings 7 correspond for example to a group of heating means 410. According to a variant, a reference marking 7 is applied for each heating means 410, preferably at the same level along the height.

According to another embodiment, a reference marking 7 is applied for each heating means 410, but at a different level along the height. In this embodiment, the difference between the height of a reference marking 7 and the height of a corresponding heating means 410 needs to be the same for each reference marking 7 applied. In other words, if, for one heating means 410, the reference marking 7 is applied two centimeters below the height of said heating means 410, each reference marking 7 for each heating means 410 will also be applied at a distance of two centimeters below the height of said heating means 410.

The at least two reference markings 7 are therefore applied along the height of the sample preform 2 at minimum at two predetermined heights.

The method also comprises, in one embodiment, a step of defining, for each format 3 of container 1, at least three sections 8 along the height of said container, each section 8 having a lower limit 810 and an upper limit 820, each lower limit 810 and/or each upper limit 820 of at least one section 8 corresponding to a height 9 of a sensor 610. For the section 8 situated at the lowest height of the container, counting from the bottom of said container, the lower limit 810 corresponds to the bottom of the container 1. For the section 8 situated at the highest height of the container, counting from the bottom, the upper limit 820 corresponds to the neck of said container 1.

Next, after the thermal conditioning of the preform 2, and after the step of blow-molding said preform in order to obtain a container 1, the method also comprises a step of attributing the heating means 410 to one of the predefined sections. This attribution step comprises a step of capturing the position of the reference markings 7 on said container 1 formed. Said measurement is followed by a step of attributing each of the heating means 410 to at least one of the sections 8, on the basis of the position, which is to say of the measured height, of the reference markings 7 on the container 1. It is conceivable that one section 8 may not be connected with one of the heating means 410, which is to say that no heating means 410 might be attributed to a section 8 concerned.

In one preferred embodiment, at least one heating means 410 is attributed to each section 8.

According to another embodiment, the capturing of the position of the reference markings 7 on the container 1 obtained is performed by any viewing means. The attribution of the heating means 410 to a section 8 may be performed by the control unit 6 or by calculation means.

In some embodiments, the attribution of the heating means 410 is performed by an operator.

Thus, according to the invention, it is possible to know precisely which heating means 410 heat the preform 2 at a given level along the height in order to produce a corresponding container 1. In other words, by means of the calibration step, it is known which of the heating means 410 are the ones that act on at least one section 8 of a container 1 during the process of producing it. If a thickness defect is detected in the wall of the container 1, it will be possible to correct the thermal conditioning in a controlled and precise manner.

According to a variant, the calibration step comprises a step of defining five sections 8 for a format 3 of container 1.

According to certain embodiments, the step of applying reference markings 7 to the sample preform 2 is performed by laser marking the circumference of said preform at a minimum of two heights.

In other embodiments, the step of applying reference markings 7 to the sample preform 2 is performed by inkjet printing on the circumference of said sample at a minimum of two heights.

In a variant, the step of applying reference markings 7 may be performed by hand, by an operator.

The reference markings may take the form of a line, of a dot, or of any other pattern.

Finally, according to one additional possible feature, each reference marking 7 applied to the preform 2 is made at the same height as the height separating two heating means 410. According to this embodiment, the step of applying the reference markings 7 corresponds to the application of a reference marking 7 for each heating means 410. Each heating means 410 is then associated with a single reference marking 7. Alternatively, it is also possible to associate a group of heating means 410 with a reference marking 7.

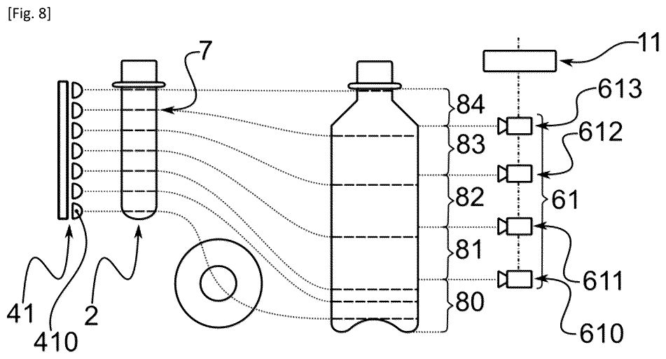

FIG. 8 shows an illustrative example in which each reference marking 7 is applied to the wall 24 of the preform 2 that faces a heating means 410. This same figure then again shows the reference markings 7 on the container 1 formed. The sections 8 have been defined beforehand and there are five of them. In this embodiment, it may be seen that two heating means 410 will be attributed to the section 84. Likewise, two heating means 410 will be attributed to the section 80. The sections 81, 82 and 83 will respectively have a single heating means 410 attributed to them. In this embodiment, the attribution means 11 and the detection means 61 formed by the thickness sensors 610 form the one same single means. In other words, the one same means, for example a viewing camera, acts as detection means 61 and as a means of capturing the reference markings 7. The control unit 6 will implement calculation means to attribute the heating means 410 to each of the sections 8 on the basis of the captured position of the reference markings 7.

In certain embodiments, the control step employed by the production method consists in comparing the thickness measurement measured at one level along the height 9 of the container 1 by the detection means 61 against a setpoint value for the same level along the height. This step makes it possible to detect a potential thickness defect at least at one level along the height of the container 1.

According to one additional feature, the method comprises an additional step that consists in correcting the heating power of the heating means 410 so as to correct the thickness defect observed at least at one level along the height 9. Having heating means 410 that are attributed specifically to sections 8 of the container 1 enables the defect to be corrected more precisely, and allows the thermal conditioning to be regulated in a localized manner. In other words, the electrical power of a heating means 410 will not be corrected unless it is attributed to the section 8 in respect of which a defect has been detected.

During this control step:
if the thickness measurement and the thickness setpoint are identical, then the control unit 6 does not modify the electrical power supplied to the heating means 410.
if the thickness measurement differs from the thickness setpoint for a given section 8, then the control unit 6 modifies the electrical power supplied to at least one heating means 410 attributed to said section 8.

According to an additional feature, if the control unit 6 notices a thickness defect at least at one height level 9, it then modifies the electrical powers of at least two heating means 410. As a preference, the sum of the electrical powers supplied to all of the heating means 410 remains identical throughout the method for producing the containers 1 for a heating module 41 and preferably for the heating unit 4. This is possible because of the specific attribution of at least one heating means 410 to a determined section 8 of the container 1.

The invention advantageously makes it possible to regulate the thermal conditioning of a preform 2 during a method for producing thermoplastics containers 1. This has the effect of optimizing the production method and of quickly and precisely correcting defects associated with poor setting of the parameters of the heating unit.

1. A method for producing containers from preforms, said containers being able to have different formats, each format of container having at least three sections along the height of the container, the method comprising at least the following steps of:
thermally conditioning a preform made of a thermoplastic material, said thermal conditioning being performed by at least one heating unit comprising at least one heating module, said heating module comprising several heating means positioned one above the other; and
blow-molding or stretch-blow-molding the container by means of a forming unit for the forming of containers,
wherein said method comprises a calibration step for at least one of the formats of container, comprising the following actions in succession:
supplying a sample preform for said format;
applying to said sample at least two reference markings distributed along the height of said sample, each of the at least two reference markings being associated with at least one heating means;
thermal conditioning of said sample and blowing of said sample in order to obtain a container to said format,
capturing of the position of the reference markings on said container obtained; and
attributing of each of the heating means to at least one of the three sections according to the position of the reference markings on said container obtained.

2. The method as claimed in claim 1, wherein it comprises a step of controlling the wall thickness of the wall of the containers at the sections, said control being performed by means of a control unit, said unit comprising detection means comprising at least two sensors, and the control step involving comparing said thickness measurement against a setpoint value.

3. The method as claimed in claim 2, wherein for at least one section, the thickness is measured by its corresponding sensor at the lower limit and/or at the upper limit of said section.

4. The method as claimed in claim 2, wherein it comprises an automatic step of regulating the power of at least one heating means on the basis of the measured thickness for the section to which said means is attributed.

5. The method for producing containers as claimed in claim 1, wherein the step of applying reference markings to the sample consists in laser marking the circumference of said sample at a minimum of two heights.

6. The method for producing containers as claimed in claim 1, wherein, during the thermal conditioning, each reference marking applied to the preform faces a heating means, and in particular faces the heating means with which it is associated.

7. A facility for producing thermoplastic containers, implementing a method as claimed in claim 1, said containers being able to have different formats, each format of container having at least three sections along the height of the container, said facility comprising:
a heating unit comprising at least one heating module, said heating module comprising several heating means positioned one above the other,
a forming unit for the forming of containers, this unit comprising at least one forming station, said forming station each including a mold the molding cavity of which matches a container, and at least one injection device for injecting a pressurized fluid into the preform,
wherein
it comprises calibration means comprising means for applying, to a sample preform, at least two reference markings that are distant from one another along the height of said sample, and attribution means for attributing each of the heating means to at least one of the three sections on the basis of the position of the reference markings on said container obtained at the exit of the forming unit.

8. The facility as claimed in claim 7, wherein it comprises a control unit for controlling the wall thickness of the wall of the containers at a minimum of two height levels, said control unit comprising detection means, said detection means comprising at least two sensors situated one above the other each at a respective height level of said container, and said control unit comprising an automatic control system.

9. The facility as claimed in claim 8, wherein the control unit comprises the attribution means and the detection means.

10. The facility as claimed in claim 7, wherein the calibration means comprise means for laser marking at least two reference markings on the circumference of the sample.

11. The facility as claimed in claim 7, wherein in the conditioning unit, each reference marking on the sample faces a heating means, and in particular faces the heating means with which it is associated.

12. A method for producing containers from preforms, the containers being able to have different formats, each format of container having at least three sections along the height of the container, the method comprising at least the following steps of:
thermally conditioning a preform made of a thermoplastic material;
blow-molding or stretch-blow-molding the container by means of a forming unit for the forming of containers; and
providing a calibration step for at least one of the formats of container, the calibration step comprising the following actions in succession:
supplying a sample preform for the format;
applying to the sample at least two reference markings distributed along the height of the sample;
thermal conditioning of the sample and blowing of the sample in order to obtain a container to the format;
capturing of the position of the reference markings on the container obtained; and
attributing of each of the heating means to at least one of the three sections according to the position of the reference markings on the container obtained.

13. The method of claim 12, wherein the thermal conditioning is performed by at least one heating unit comprising at least one heating module, the heating module comprising several heating means positioned one above the other.

14. The method of claim 12, wherein each of the at least two reference markings are associated with at least one heating means.
